(19) United States
(12) Patent Application Publication
(10) Pub. No.: US 2017/0328719 A1
(43) Pub. Date: Nov. 16, 2017

(54) EVALUATION INFORMATION COLLECTING SYSTEM

(71) Applicant: MITSUBISHI ELECTRIC CORPORATION, Tokyo (JP)

(72) Inventor: Keita YAMAMURO, Tokyo (JP)

(73) Assignee: MITSUBISHI ELECTRIC CORPORATION, Tokyo (JP)

(21) Appl. No.: 15/520,160

(22) PCT Filed: Jan. 30, 2015
(86) PCT No.: PCT/JP2015/052722

§ 371 Date: Apr. 19, 2017

(51) Int. Cl. G01C 21/26; G08G 1/13; G06F 17/30

(52) U.S. Cl. CPC G01C 21/26; G08G 1/13; G06F 17/30241

(57) ABSTRACT

An evaluation information collecting system compares a standard moving state estimated using environment information about the periphery of the current location of a mobile object with a current moving state estimated using mobile object information indicating a moving state of the mobile object, and in a case in which there is a difference between both states, acquires evaluation information pieces existing within a preset map range including the current location, and in a case in which the number of acquired evaluation information pieces is less than a threshold, decides to make an inquiry so as to collect evaluation information.

### TECHNICAL FIELD

The present invention relates to an evaluation information collecting system for inquiring of a user about evaluation information on the periphery of a mobile object.

### BACKGROUND ART

When a user is driving a vehicle, the user sometimes has various types of impressions such as a good impression and a bad impression about a road on which the user is traveling, and its surrounding situation. If the impression that the user had can be registered on a map as evaluation information, the user can transfer in such a manner as to pass or avoid the registered point at the next times onward. However, the manual registration of the evaluation information during the driving imposes a burden on the user. If such impression is registered after the stopping of the vehicle, it is difficult for the user itself to memorize the evaluation information for a long time until the vehicle stops.

For solving this problem, as in Patent Literature 1 for example, there is an evaluation information collecting system that causes a user to register evaluation information by using hands-free voice recognition. However, because the method described in Patent Literature 1 is a method of performing voice recognition of conversation made by users in a vehicle and converting the recognized voice into evaluation information, the evaluation information cannot be efficiently collected in a situation in which less conversation is made in a vehicle, namely, a situation in which there is only one occupant in the vehicle.

Thus, as in Patent Literature 2 for example, a method of inquiring a user by a system so as to collect the evaluation information is conceivable. In the method described in Patent Literature 2, if vehicle information related to the traveling of the user's vehicle satisfies a dialog start condition, utterance to the user is started, and interactive information is provided.

### CITATION LIST

### Patent Literatures

Patent Literature 1: WO 2014/057540 A

Patent Literature 2: JP 2003-329477 A

### SUMMARY OF INVENTION

### Technical Problem

If the inquiry method according to Patent Literature 2 is applied to the evaluation information collecting system according to Patent Literature 1, inquiries from the system to the user are started in the case where the vehicle information related to the traveling of the user's vehicle satisfies the dialog start condition, and voice recognition of the utterance of the user that has responded to the inquiry is performed, and the recognized voice is converted into evaluation information. However, this method has the following problems (1) to (3).

(1) There is a problem in that because it is determined based only on the vehicle information whether to make the inquiries from the system to the user, the inquiries are made more than necessary, which imposes a burden on the user. For example, the inquiries are made notwithstanding the number of pieces of evaluation information is sufficiently registered in the system, and further registration is not necessary.

(2) There is a problem in that because an inquiry start timing is determined based only on the vehicle information, the inquiry is started at timing at which the user is concentrating on the driving, and the user's attention is diverted. For example, inquiry is started at an area in which the user needs to concentrate on the driving, namely, at a sharp curve.

(3) There is a problem in that because peripheral surroundings of the location of the user's vehicle cannot be estimated only based on the vehicle information, inquiry words become abstractive. Because various types of evaluation information lacking in coherence are collected from the user who freely responds to abstractive inquiry words, and effective evaluation information related to the location of the user's vehicle is not sufficiently collected, and reliability of the evaluation information decreases. For example, if the system inquires of the user “What happen?”, the user returns various responses such as “I am hungry”, “traffic is heavy”, and “I am sleepy”. Thus, effective responses, which serve as the evaluation information about the periphery of the location of the user's vehicle, cannot be easily collected, and the reliability of the evaluation information decreases.

The present invention has been devised for solving at least (1) of the above-described problems (1) to (3), and it is an object of the present invention to avoid making unnecessary inquiries to reduce a burden on a user.

### Solution to Problem

An evaluation information collecting system according to the present invention includes an environment information acquisition unit for acquiring environment information indicating peripheral surroundings at a current location of a mobile object, a standard moving state estimation unit for estimating a standard moving state at the current location with the environment information acquired by the environment information acquisition unit, a mobile object information acquisition unit for acquiring mobile object information indicating a moving state of the mobile object, a current moving state estimation unit for estimating a current moving state of the mobile object with the mobile object information acquired by the mobile object information acquisition unit, a difference determination unit for determining whether there is a difference between the standard moving state and the moving state of the mobile object, by comparing the standard moving state with the moving state of the mobile object, an evaluation information acquisition unit for acquiring evaluation information existing within a preset map range including the current location, in a case in which it is determined by the difference determination unit that there is the difference, and an inquiry decision unit for deciding to make an inquiry so as to collect the evaluation information, in a case in which the number of pieces of evaluation information acquired by the evaluation information acquisition unit is less than a threshold.

### Advantageous Effects of Invention

According to the present invention, an inquiry for collecting evaluation information is made in a case in which there is a difference between a standard moving state and a moving state of a mobile object, and in a case in which the number of pieces of evaluation information about the periphery of a current location is less than a threshold, so that the inquiry is not made in a case in which the number of pieces of evaluation information to be collected has already sufficiently been increased, which reduces a burden on the user.

### BRIEF DESCRIPTION OF DRAWINGS

FIG. 1 is a block diagram illustrating a configuration example of an evaluation information collecting system according to a first embodiment of the present invention.

FIG. 2 is a diagram illustrating a map screen example displayed on a display by a navigation device.

FIG. 3 is a hardware configuration diagram of the evaluation information collecting system according to the first embodiment.

FIG. 4 is a diagram illustrating a method for determining a difference between a standard traveling state and a current traveling state.

FIG. 5 is a diagram illustrating an example of evaluation information stored in an evaluation information storage of a server.

FIG. 6 is a flowchart illustrating an operation of the evaluation information collecting system according to the first embodiment.

FIG. 7 is a block diagram illustrating a configuration example of an evaluation information collecting system according to a second embodiment of the present invention.

FIG. 8 is a diagram illustrating an example of a correspondence table between parameters of a traveling state and types of evaluation information that is used by a cause estimation unit.

FIG. 9 is a flowchart illustrating an operation of the evaluation information collecting system according to the second embodiment.

FIG. 10 is a diagram illustrating a map screen example displayed on a display by a navigation device.

FIG. 11 is a block diagram illustrating a configuration example of an evaluation information collecting system according to a third embodiment of the present invention.

FIG. 12 is a diagram illustrating an example of a correspondence table between types of evaluation information and inquiry modes that is used by an inquiry mode decision unit.

FIGS. 13A and 13B are a diagram illustrating a method for identifying a type of evaluation information for which inquiry is made.

FIG. 14 is a flowchart illustrating an operation of the evaluation information collecting system according to the third embodiment.

FIG. 15 is a diagram illustrating an example of a correspondence table between types of evaluation information and priority orders that is used by an inquiry mode decision unit of an evaluation information collecting system according to a fourth embodiment of the present invention.

FIG. 16 is a flowchart illustrating an operation of the evaluation information collecting system according to the fourth embodiment.

### DESCRIPTION OF EMBODIMENTS

For describing the present invention in more detail, a mode for carrying out the present invention will be described below in accordance with attached drawings.

### First Embodiment

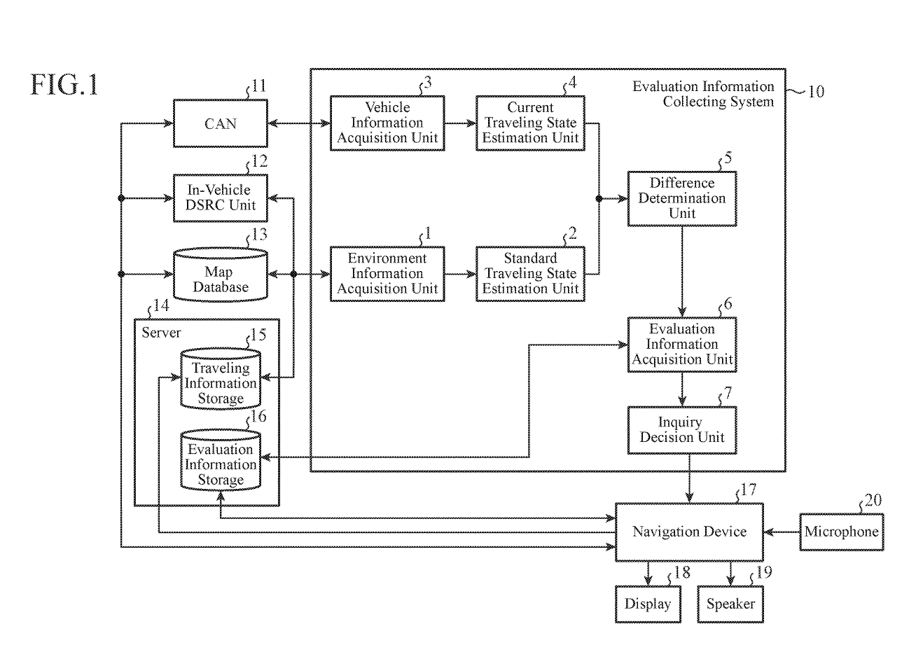

FIG. 1 is a block diagram illustrating a configuration example of an evaluation information collecting system 10 according to a first embodiment of the present invention.

The evaluation information collecting system 10 according to the present invention collects, as evaluation information, an evaluation comment or the like about the periphery of the location of a user's vehicle, which has been posted by a user such as a driver, in association with the location of the user′ vehicle. The collected evaluation information is shared among a plurality of vehicles via a server 14.

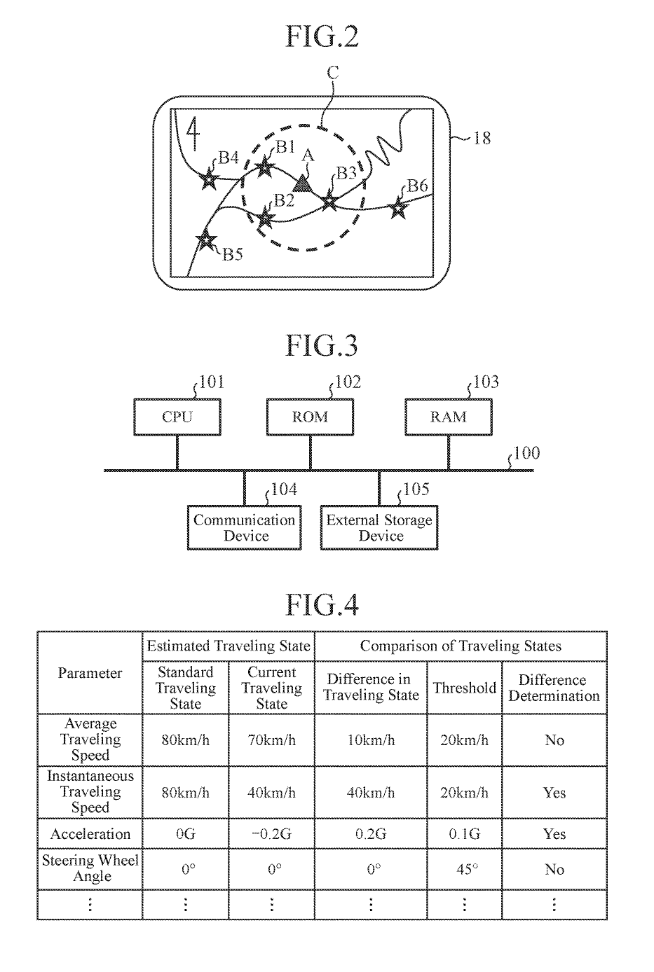

In the present invention, the description will be given assuming that the evaluation information collecting system 10 is used in combination with a navigation device 17, and the navigation device 17 receives evaluation information from the server 14 and displays the received evaluation information on a map, whereby the evaluation information is shared among a plurality of vehicles. For example, as illustrated in FIG. 2, the navigation device 17 displays, on a display 18, a screen in which evaluation information pieces B1 to B6 existing in the periphery of a location A of the user's vehicle are arranged on the map.

In addition, if a difference between a current traveling state of the user's vehicle and a standard traveling state on a road on which the user's vehicle is traveling is large, the evaluation information collecting system 10 determines that some event such as traffic jam, which serves as an evaluation target, exists in the periphery of the location of the user's vehicle. In addition, the evaluation information collecting system 10 instructs the navigation device 17 to make an inquiry for collecting evaluation information, in a case in which the number of pieces of evaluation information about the periphery of the location of the user's vehicle is few, that is, only in a case in which the reliability of evaluation for the event is low, and the reliability needs to be improved by increasing the number of pieces of evaluation information. In response to the instructions from the evaluation information collecting system 10, the navigation device 17 makes an inquiry, causes the user to make a reply such as an evaluation comment related to the periphery of the location of the user's vehicle, generates the evaluation information in which the evaluation comment or the like and the location of the user's vehicle are associated, and transmits the generated evaluation information to the server 14.

In addition to the above-described navigation device 17, a controller area network (CAN) 11 and an in-vehicle dedicated short range communication (DSRC) unit 12 are connected to the evaluation information collecting system 10. The navigation device 17 includes the display 18, a speaker 19, and a microphone 20.

A map database 13 stores map data. The map database 13 may be provided in a vehicle, or may be provided on the outside of the vehicle.

The server 14 includes a traveling information storage 15 and an evaluation information storage 16. The server 14 collects the evaluation information from the navigation device 17 that is provided on the outside of other vehicles and mounted on the user's vehicle, stores the collected evaluation information in the evaluation information storage 16, and transmits the evaluation information stored in the evaluation information storage 16, to the navigation device 17 mounted on another vehicle. This enables the evaluation information to be shared among a plurality of vehicles.

In addition, the server 14 receives, from the navigation device 17 mounted on the user's vehicle, the traveling information of the user's vehicle, stores the traveling information in the traveling information storage 15, and transmits the traveling information stored in the traveling information storage 15, to the evaluation information collecting system 10 mounted on the user's vehicle or another vehicle.

The evaluation information collecting system 10 includes an environment information acquisition unit 1, a standard traveling state estimation unit 2, a vehicle information acquisition unit 3, a current traveling state estimation unit 4, a difference determination unit 5, an evaluation information acquisition unit 6, and an inquiry decision unit 7.

Here, FIG. 3 illustrates a hardware configuration example of the evaluation information collecting system 10.

A central processing unit (CPU) 101, a read only memory (ROM) 102, a random access memory (RAM) 103, a communication device 104, and an external storage device 105 are connected to a bus 100.

By reading out and executing various programs stored in the ROM 102 or the external storage device 105, the CPU 101 implements the functions of the environment information acquisition unit 1, the standard traveling state estimation unit 2, the vehicle information acquisition unit 3, the current traveling state estimation unit 4, the difference determination unit 5, the evaluation information acquisition unit 6, and the inquiry decision unit 7 of the evaluation information collecting system 10, in cooperation with each piece of hardware.

The RAM 103 is a memory used in the execution of programs.

The communication device 104 is a communication terminal for downloading information from the external server 14 and uploading information to the external server 14, via a network. The communication device 104 implements the functions of the environment information acquisition unit 1 and the evaluation information acquisition unit 6 for acquiring information from the server 14 via a network. In addition, in the case of using the map database 13 provided on the outside of the user's vehicle, the environment information acquisition unit 1 implements the function of acquiring information from the map database 13 via a network.

The external storage device 105 includes a storage device such as a hard disk drive (HDD), a compact disc (CD), and a digital versatile disk (DVD), a storage device employing a semiconductor memory such as a universal serial bus (USB) memory and a secure digital (SD) card, or the like.

The environment information acquisition unit 1 acquires environment information about the periphery of the location of the user's vehicle from at least one of the in-vehicle DSRC unit 12, the map database 13, and the traveling information storage 15 and outputs the acquired environment information to the standard traveling state estimation unit 2.

The environment information is information for estimating a standard traveling state in the standard driving of a general driver on a road on which the user's vehicle is currently traveling, that is, a standard traveling state, in the standard traveling state estimation unit 2 to be described later.

Specifically, the environment information acquisition unit 1 acquires, as the environment information, from the in-vehicle DSRC unit 12, the presence or absence of a signal in the periphery of the location of the user's vehicle, the lighting color of the signal, or the like.

In addition, the environment information acquisition unit 1 acquires, as the environment information, from the map database 13, road information that indicates a speed limit on a road in the periphery of the location of the user's vehicle, a radius of a curve of the road, and the like.

In addition, the environment information acquisition unit 1 acquires, as the environment information, from the server 14 via a network, the traveling information such as a traveling speed or acceleration/deceleration of another vehicle in the periphery of the location of the user's vehicle, or the traveling information of the user's vehicle such as an average traveling speed or average acceleration/deceleration that is based on the traveling history of the user's vehicle.

In addition, the environment information acquisition unit 1 acquires, as the environment information, from the navigation device 17, a current location of the user's vehicle, current date and time, a time elapsed from when the user's vehicle has started traveling, or the like.

Incidentally, the description has been given assuming that the environment information acquisition unit 1 directly acquires the environment information from the in-vehicle DSRC unit 12, the map database 13, and the like. Alternatively, the environment information acquisition unit 1 may acquire the environment information via the navigation device 17. The environment information acquisition unit 1 may acquire the environment information from any information source and via any route as long as the environment information acquisition unit 1 can acquire the environment information.

The standard traveling state estimation unit 2 receives the environment information acquired by the environment information acquisition unit 1, estimates a standard traveling state in the standard driving of a general driver on a road on which the user's vehicle is currently traveling, that is, a standard traveling state, and outputs the standard traveling state to the difference determination unit 5.

For example, the standard traveling state estimation unit 2 estimates a speed within a preset range from the speed limit of the road on which the user's vehicle is currently traveling, as the standard traveling state. Specifically, in the case of a road, the speed limit of which is 50 km/h, the standard traveling state estimation unit 2 estimates 50 km/h as the standard traveling state. In addition, for example, the standard traveling state estimation unit 2 may calculate an average value of traveling speeds of other vehicles at the current location of the user's vehicle and estimate the calculated average value as the standard traveling state.

In addition, for example, the standard traveling state estimation unit 2 may calculate a steering wheel angle with the radius of a curve of the road and estimate the steering wheel angle as the standard traveling state.

In addition, the method of estimating the standard traveling state is not limited to the above-described methods. In addition, a plurality of kinds of standard traveling states may be estimated.

The vehicle information acquisition unit 3 acquires vehicle information from the CAN 11 or the like and outputs the acquired vehicle information to the current traveling state estimation unit 4.

The vehicle information is information for estimating a current traveling state of the user's vehicle, that is, a current traveling state, in the current traveling state estimation unit 4 to be described later.

Specifically, the vehicle information acquisition unit 3 acquires, as the vehicle information, from the CAN 11, traveling speed, acceleration/deceleration, a steering wheel angle, steering wheel angle speed, and the like, and acquires information of ON/OFF of an in-vehicle device such as a headlight, a blinker, and a windshield wiper.

In addition, the description has been given assuming that the vehicle information acquisition unit 3 directly acquires vehicle information from the CAN 11 or the like. Alternatively, the vehicle information acquisition unit 3 may acquire the vehicle information via the navigation device 17. The vehicle information acquisition unit 3 may acquire the vehicle information from any information source and via any route as long as the vehicle information acquisition unit 3 can acquire the vehicle information.

The current traveling state estimation unit 4 receives the vehicle information acquired by the vehicle information acquisition unit 3, estimates a current traveling state of the user's vehicle, that is, a current traveling state, and outputs the current traveling state to the difference determination unit 5.

For example, the current traveling state estimation unit 4 calculates average traveling speed using the traveling speeds of the user's vehicle within a preset time, and estimates the average traveling speed as the current traveling state. Specifically, if the traveling speed of the user's vehicle in a period ranging from a few seconds ago to the present moment is approximately 50 km/h, the current traveling state estimation unit 4 estimates the average traveling speed 50 km/h of the user's vehicle on the road on which the user's vehicle is currently traveling, as the current traveling state. In addition, for example, the current traveling state estimation unit 4 may estimate instantaneous traveling speed, which is the current traveling speed of the user's vehicle, as the current traveling state.

In addition, for example, the current traveling state estimation unit 4 may estimate the steering wheel angle, steering wheel acceleration, or steering wheel angle speed of the user's vehicle, and the like, as the current traveling state.

In addition, the method of estimating the current traveling state is not limited to the above-described methods. In addition, a plurality of kinds of current traveling states may be estimated.

The difference determination unit 5 receives the standard traveling state from the standard traveling state estimation unit 2, receives the current traveling state from the current traveling state estimation unit 4, determines whether there is a difference by comparing the standard traveling state with the current traveling state, and notifies the evaluation information acquisition unit 6 of the difference when determining that there is the difference.

When there is the difference between the standard traveling state and the current traveling state, the difference determination unit 5 determines that some event that serves as an evaluation target exists in the periphery of the location of the user's vehicle. In contrast, when there is no difference, the difference determination unit 5 determines that the event does not exist. The event that serves as an evaluation target can be a determination criterion used by a driver who determines whether to pass a certain area, for example, such as an area where traffic jam occurs, an area where landscape is beautiful, and a dangerous area in traveling.

Here, FIG. 4 illustrates an example of a method for determining a difference between the standard traveling state and the current traveling state.

The difference between the standard traveling state and the current traveling state is a difference in parameters of the standard traveling state and the current traveling state as illustrated in FIG. 4. If parameters in the both states are the same, the difference determination unit 5 determines that there is no difference, and if the parameters are not the same, the difference determination unit 5 determines that there is a difference. The parameters include average traveling speed, instantaneous traveling speed, acceleration, a steering wheel angle, steering wheel angle speed, and the like.

In addition, a threshold may be preset for each parameter of the standard traveling state and the current traveling state, and the difference determination unit 5 may determine that no difference exists when a difference in parameters in both states is less than the threshold, or may determine that a difference exists when the difference is equal to or larger than the threshold. In addition, the difference determination unit 5 may simultaneously compare the standard traveling state with the current traveling state for two or more parameters, or when the number of parameters having differences is larger than a preset number of parameters, the difference determination unit 5 may determine that a difference exists between the both states, and when the number of parameters having differences is equal to or smaller than the preset number of parameters, the difference determination unit 5 may determine that no difference exists between the both states.

Specifically, for example, in the case where the parameter is the average traveling speed, a difference of 10 km/h between a standard traveling state of 80 km/h and a current traveling state of 70 km/h is less than a threshold 20 km/h, so that the difference determination unit 5 determines that no difference exists.

In the case where it is determined that there exists a difference in the average traveling speed between both states, for example, it is conceivable that the vehicle has decelerated because the vehicle gets caught up in a traffic jam, or that the vehicle has decelerated because the vehicle is passing through an area where landscape is beautiful. In other words, there is a possibility that some event that brings about a cause leading to a difference in the average traveling speed exists in the periphery of the location of the user's vehicle.

In addition, for example, in the case where the parameter is the instantaneous traveling speed, a difference of 40 km/h between a standard traveling state of 80 km/h and a current traveling state of 40 km/h is equal to or larger than a threshold of 20 km/h, so that the difference determination unit 5 determines that a difference exists.

In the case where it is determined that there exists a difference in the instantaneous traveling speed between both states, it is conceivable that the vehicle has decelerated because the vehicle gets caught up in a traffic jam, or that the vehicle has decelerated at a dangerous place such as a sharp curve. In other words, there is a possibility that some event that brings about a cause leading to a difference in the instantaneous traveling speed exists in the periphery of the location of the user's vehicle.

In addition, for example, in the case where the parameter is the acceleration, a difference of 0.2 G between a standard traveling state of 0 G and a current traveling state of −0.2 G is equal to or larger than a threshold of 0.1 G, so that the difference determination unit 5 determines that a difference exists.

In the case where it is determined that there exists a difference in the acceleration between both states, it is conceivable that the vehicle has decelerated because the vehicle gets caught up in a traffic jam, or that the vehicle has decelerated at a dangerous place such as a sharp curve. In other words, there is a possibility that some event that brings about as a cause leading to a difference in the acceleration exists in the periphery of the location of the user's vehicle.

In addition, for example, in the case where the parameter is the steering wheel angle, a difference of 0 degree between a standard traveling state of 0 degree and a current traveling state of 0 degree is less than a threshold of 45 degree, so that the difference determination unit 5 determines that no difference exists.

In the case where it is determined that there exists a difference in the steering wheel angle between both states, it is conceivable that a driver has greatly turned a steering wheel at a dangerous place such as a sharp curve. In other words, there is a possibility that some event that brings about as a cause leading to a difference in the steering wheel angle exists in the periphery of the location of the user's vehicle.

A threshold for determining a difference between the standard traveling state and the current traveling state is assumed to be given to the difference determination unit 5 in advance.

In addition, the threshold needs not be a fixed value, and may dynamically vary in accordance with the value of the standard traveling state. For example, a threshold in the case where the average traveling speed in the standard traveling state is 80 km/h is set to 20 km/h, and a threshold in the case where the average traveling speed in the standard traveling state is 40 km/h is set to 10 km/h.

In addition, the ranges of the threshold may be extended by setting the upper limit and the lower limit of the threshold. For example, in the case in which the difference determination unit 5 uses ±20 km/h as the threshold of the average traveling speed of 80 km/h in the standard traveling state, when the average traveling speed in the current traveling state falls within the range from 60 to 100 km/h, the difference determination unit 5 determines that no difference exists, and when the average traveling speed is equal to or lower than 60 km/h, or equal to or higher than 100 km/h, the difference determination unit 5 determines that a difference exists. In a case in which the average traveling speed in the current traveling state is equal to or lower than 60 km/h, it is conceivable that the vehicle has decelerated because the vehicle gets caught up in a traffic jam. In contrast, in the case in which the average traveling speed in the current traveling state is equal to or higher than 100 km/h, it is conceivable that the vehicle has accelerated due to the ease of the traffic jam.

The evaluation information acquisition unit 6 receives a determination result from the difference determination unit 5, and if the determination result indicates that a difference exists, the evaluation information acquisition unit 6 acquires evaluation information existing within a preset map range, centering on the present location of the user's vehicle, from the evaluation information storage 16 of the server 14 via a network, and outputs the acquired evaluation information to the inquiry decision unit 7.

For example, the preset map range is assumed to be a circle having a radius of 1 km, centering on the location of the user's vehicle. In the case where the evaluation information pieces B1 to B6 exist in the periphery of the location A of the user's vehicle in the map screen illustrated in FIG. 2, the evaluation information acquisition unit 6 acquires the evaluation information pieces B1 to B3 existing in a map range C having a radius of 1 km, centering on the location A of the user's vehicle.

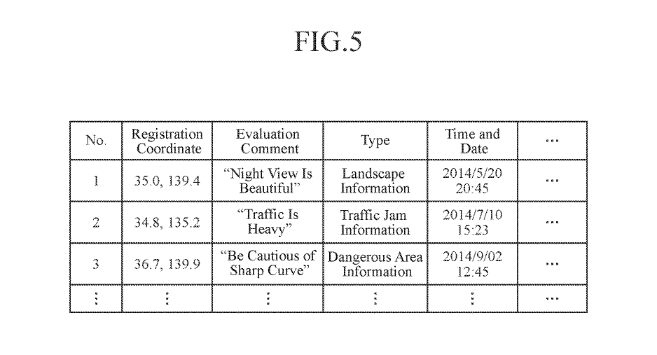

Here, FIG. 5 illustrates an example of the evaluation information stored in the evaluation information storage 16 of the server 14.

The evaluation information is information in which at least either one of an evaluation comment registered with the utterance of a user such as a driver, and the type of evaluation comment is associated with registration coordinates, which indicate the location of the user's vehicle obtained in the case where the evaluation comment or the type has been registered. Incidentally, the evaluation information may include other types of information such as time and date, weather, and the like at the time of the registration.

The evaluation information acquisition unit 6 acquires the evaluation information of the registration coordinates included in the preset map range, in which the present location of the user's vehicle is centered, from the evaluation information storage 16.

The inquiry decision unit 7 receives the evaluation information from the evaluation information acquisition unit 6, and compares the number of pieces of received evaluation information with a preset threshold. As a result of the comparison, if the number of pieces of evaluation information is less than the threshold, the inquiry decision unit 7 decides to make an inquiry for collecting the evaluation information at the present location of the user's vehicle, and instructs the navigation device 17 to make an inquiry.

The threshold is a reference value for determining, if the number of pieces of evaluation information acquired by the evaluation information acquisition unit 6 is small, that the reliability with respect to an event in the periphery of the location of the user's vehicle is low due to the insufficiency of the evaluation information pieces. In this case, the reliability with respect to the event is improved by further collecting evaluation information pieces related to the event and increasing the number of pieces of evaluation information.

Specifically, in the case where the number of pieces of evaluation information acquired by the evaluation information acquisition unit 6 is five, and a threshold preset in the inquiry decision unit 7 is eight, the number of pieces of evaluation information is less than the threshold, so that the inquiry decision unit 7 decides to inquire of the driver so as to collect the evaluation information.

Incidentally, the threshold needs not be a fixed value, and may dynamically vary in accordance with traffic volume or the like at the location of the user's vehicle.

When the navigation device 17 receives the instructions for making the inquiry from the inquiry decision unit 7, the navigation device 17 displays preset inquiry words on the display 18, or outputs voice from the speaker 19. The inquiry words may be set in advance in the navigation device 17, or may be set in advance in the inquiry decision unit 7.

Specifically, the navigation device 17 inquires of the driver by reproducing inquiry words such as “What happen?” and “What is the problem?” from the speaker 19, as audio guidance, or displaying the inquiry words on the display 18. In response to the inquiry, the driver speaks evaluation comments such as “night view is beautiful” and “traffic is heavy”. The spoken voice of the driver is collected by the microphone 20 and input to the navigation device 17.

The navigation device 17 performs recognition processing of the spoken voice input from the microphone 20, generates an evaluation comment, generates evaluation information by associating the evaluation comment with location information, and transmits the evaluation information to the server 14 via a network. When the server 14 receives the evaluation information from the navigation device 17, the server 14 stores the evaluation information in the evaluation information storage 16.

Incidentally, the types of evaluation comment included in the evaluation information may be determined by the navigation device 17 causing the driver to speak with audio guidance or the like, or may be determined by the navigation device 17 or the server 14 that analyzes the content of the evaluation comment.

In addition, in the above description, the evaluation information collecting system 10 is configured to generate the evaluation information by inquiring of the driver with the display 18, the speaker 19, and the microphone 20 connected to the navigation device 17. However, the configuration of the evaluation information collecting system 10 is not limited to this configuration. For example, the evaluation information collecting system 10 itself may include the display 18, the speaker 19, the microphone 20, and the like, and may inquire of the driver and generate the evaluation information. In addition, for example, the evaluation information may be generated by performing recognition processing of spoken voice collected by the microphone 20, in the server 14. In this manner, the execution of the inquiry and the generation of the evaluation information may be performed by any device.

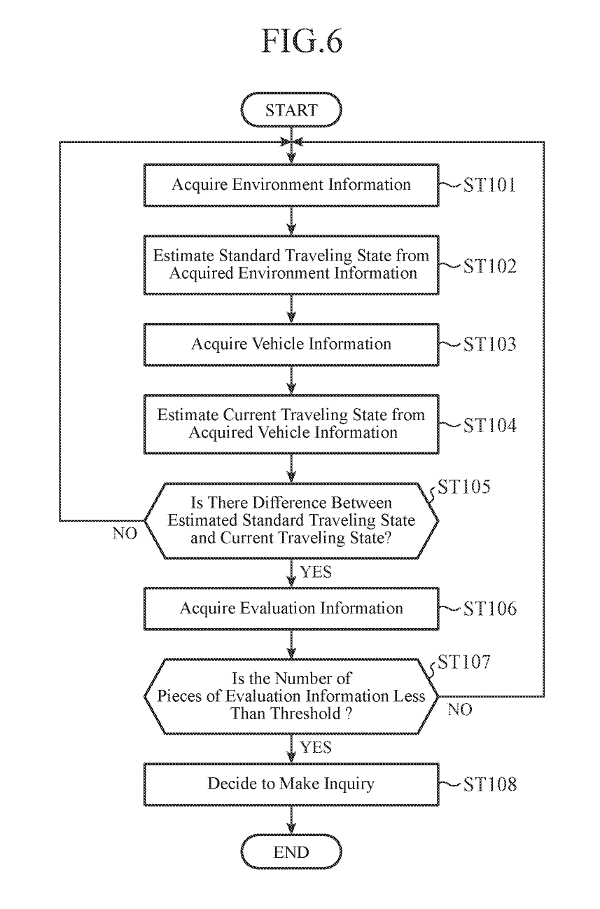

Next, the operation of the evaluation information collecting system 10 according to the first embodiment will be described with reference to a flowchart illustrated in FIG. 6. The evaluation information collecting system 10 repeats the operation illustrated in the flowchart, for a period during which the engine of the vehicle is turned on and then turned off, or for a period during which the evaluation information collecting system 10 is turned on and then turned off.

The environment information acquisition unit 1 acquires environment information about the periphery of the location of the user's vehicle from at least one of the in-vehicle DSRC unit 12, the map database 13, and the traveling information storage 15 of the server 14, and outputs the acquired environment information to the standard traveling state estimation unit 2 (step ST101). The standard traveling state estimation unit 2 estimates a standard traveling state in the location of the user's vehicle with the environment information acquired by the environment information acquisition unit 1 and outputs the standard traveling state to the difference determination unit 5 (step ST102).

The vehicle information acquisition unit 3 acquires the vehicle information of the user's vehicle from the CAN 11 and outputs the acquired vehicle information to the current traveling state estimation unit 4 (step ST103). The current traveling state estimation unit 4 estimates a current traveling state of the user's vehicle with vehicle information acquired by the vehicle information acquisition unit 3 and outputs the current traveling state to the difference determination unit 5 (step ST104).

Subsequently, the difference determination unit 5 determines the presence or absence of a difference between both states by comparing parameters in the standard traveling state estimated by the standard traveling state estimation unit 2, and parameters in the current traveling state estimated by the current traveling state estimation unit 4, and outputs a determination result to the evaluation information acquisition unit 6 (step ST105).

If the difference determination unit 5 determines that there exists a difference between the standard traveling state and the current traveling state (step ST105 “YES”), the evaluation information acquisition unit 6 acquires evaluation information, which exists within the preset map range inclusive of the location of the user's vehicle, from the evaluation information storage 16 of the server 14, and outputs the evaluation information to the inquiry decision unit 7 (step ST106). In contrast, when the difference determination unit 5 determines that no difference exists between the standard traveling state and the current traveling state (step ST105 “NO”), the evaluation information collecting system 10 returns to step ST101 and executes again the processing in steps ST101 to ST105.

After the processing in step ST106, the inquiry decision unit 7 compares the number of pieces of evaluation information acquired by the evaluation information acquisition unit 6, with a threshold (step ST107). If the acquisition number of pieces of evaluation information is less than the threshold (step ST107 “YES”), the inquiry decision unit 7 determines that the reliability with respect to an event that serves as an evaluation target in the periphery of the location of the user's vehicle is low due to the insufficiency of the current number of pieces of evaluation information, decides to inquire of the driver so as to collect the evaluation information, and instructs the navigation device 17 to make an inquiry (step ST108). After step ST108, the evaluation information collecting system 10 returns again to step ST101 and executes again the processing in steps ST101 to ST108.

In contrast, if the acquisition number of pieces of evaluation information is equal to or larger than the threshold (step ST107 “NO”), the inquiry decision unit 7 determines that the reliability with respect to the event that serves as an evaluation target in the periphery of the location of the user's vehicle is sufficiently high with the current number of pieces of evaluation information, decides not to inquire of the driver, and returns to step ST101.

In addition, the processing in steps ST101 and ST102 and the processing in steps ST103 and ST104 may be executed in a reverse order, or may be concurrently executed.

The above processing described with the flowchart will be described below with specific examples.

For example, the processing in the flowchart illustrated in FIG. 6 will be described with an example in which the user's vehicle gets caught up in a traffic jam during the travelling on a superhighway, which causes the user's vehicle to decelerate.

The environment information acquisition unit 1 acquires, as environment information, a speed limit 80 of km/h on a road on which the user's vehicle is traveling, and road information indicating that the road is a straight road, from the map database 13 (step ST101). Subsequently, the standard traveling state estimation unit 2 estimates the speed limit of 80 km/h acquired from the environment information acquisition unit 1, as the average traveling speed in the standard traveling state (step ST102). In addition, the standard traveling state estimation unit 2 determines, based on the road information acquired by the environment information acquisition unit 1, that the road on which the user's vehicle is traveling is straight, and that the user's vehicle is less likely to decelerate, and estimates acceleration in the standard traveling state as 0 G (step ST102).

The vehicle information acquisition unit 3 acquires, as vehicle information, a traveling speed of 40 km/h of the user's vehicle and the current acceleration of −0.2 G from the CAN 11 or the like (step ST103). Subsequently, the current traveling state estimation unit 4 calculates an average traveling speed of 70 km/h from the traveling speed of 40 km/h acquired by the vehicle information acquisition unit 3, and the traveling speeds of the user's vehicle in past five seconds, and estimates the calculated speed of 70 km/h as the average traveling speed in the current traveling state (step ST104). In addition, the current traveling state estimation unit 4 estimates the current acceleration of −0.2 G acquired by the vehicle information acquisition unit 3, as the acceleration in the current traveling state (step ST104).

Subsequently, the difference determination unit 5 determines whether there exists a difference between the standard traveling state and the current traveling state (step ST105). For example, a correspondence table, in which correspondence relationship between values of the standard traveling state and thresholds is set, is given in advance to the difference determination unit 5. In this correspondence table, for example, the threshold of 20 km/h is set for the average traveling speed of 80 km/h in the standard traveling state, and the threshold of 10 km/h is set for the average traveling speed of 40 km/h.

First, the difference determination unit 5 compares a difference of 10 km/h between the average traveling speed of 80 km/h in the standard traveling state and the average traveling speed of 70 km/h in the current traveling state, with the threshold of 20 km/h set in the correspondence table. As a result of comparison, because the difference in the average traveling state is less than the threshold, the difference determination unit 5 determines that no difference exists in the average traveling speed.

In a similar manner, the difference determination unit 5 compares a difference of 0.2 G between the acceleration of 0 G in the standard traveling state and the acceleration of −0.2 G in the current traveling state, with the threshold of 0.1 G set in the correspondence table. As a result of comparison, because the difference in the acceleration is equal to or larger than the threshold, the difference determination unit 5 determines that there exists a difference in the acceleration.

Since there is a difference in the acceleration, which is one of parameters in the standard traveling state and the current traveling state, the difference determination unit 5 finally determines that there exists a difference between both states (step ST105 “YES”), and determines that some event that brings about as a cause leading to the difference in the acceleration exists in the periphery of the location of the user's vehicle.

If the difference determination unit 5 determines that there is a difference between the standard traveling state and the current traveling state (step ST105 “YES”), the evaluation information acquisition unit 6 acquires evaluation information, which exists within the preset map range inclusive of the location of the user's vehicle, from the evaluation information storage 16 (step ST106). For example, in the map screen illustrated in FIG. 2, the six evaluation information pieces B1 to B6 exist in the periphery of the location A of the user's vehicle. In this case, the evaluation information acquisition unit 6 acquires the three evaluation information pieces B1 to B3 existing in the map range C having a radius of 1 km, centering on the location A of the user's vehicle.

If the number of pieces of evaluation information acquired by the evaluation information acquisition unit 6 is less than the threshold, the inquiry decision unit 7 decides to make an inquiry and instructs the navigation device 17 (step ST108). For example, if the threshold preset in the inquiry decision unit 7 is five, the number of pieces of evaluation information acquired by the evaluation information acquisition unit 6 in the example illustrated in FIG. 2 is three, which is less than the threshold, so that the inquiry decision unit 7 decides to inquire of the driver so as to collect the evaluation information.

When the navigation device 17 receives the instructions for making the inquiry from the inquiry decision unit 7, for example, the navigation device 17 instructs the speaker 19 to output “What happen?” as audio guidance.

As described above, according to the first embodiment, the evaluation information collecting system 10 includes the environment information acquisition unit 1 for acquiring environment information indicating peripheral surroundings at the location of the user's vehicle, the standard traveling state estimation unit 2 for estimating a standard traveling state at the location of the user's vehicle with the environment information acquired by the environment information acquisition unit 1, the vehicle information acquisition unit 3 for acquiring vehicle information indicating a traveling state of the user's vehicle, the current traveling state estimation unit 4 for estimating a current traveling state of the user's vehicle with the vehicle information acquired by the vehicle information acquisition unit 3, the difference determination unit 5 for determining whether there is a difference between the standard moving state and the moving state of the mobile object, by comparing the standard traveling state and the current traveling state, the evaluation information acquisition unit 6 for acquiring evaluation information existing within a preset map range including the location of the user's vehicle, in a case in which it is determined by the difference determination unit 5 that there is the difference, and the inquiry decision unit 7 for deciding to make an inquiry so as to collect evaluation information, in a case in which the number of pieces of evaluation information acquired by the evaluation information acquisition unit 6 is less than a threshold. Accordingly, the inquiry is not made in the case in which the number of pieces of evaluation information to be collected has already sufficiently been increased, so that a burden on the user such as the driver can be reduced. In addition, because only deficient evaluation information can be efficiently collected, the reliability of evaluation information can be improved.

In addition, in the first embodiment, the description has been given assuming a case in which the evaluation information collecting system 10 is mounted on a vehicle. However, the application of the evaluation information collecting system 10 is not limited to vehicles, and the evaluation information collecting system 10 may be employed for a mobile object such as persons, ships, and aircrafts.

In this case, the environment information acquisition unit 1 acquires environment information indicating peripheral surroundings at the current location of the mobile object.

The standard traveling state estimation unit 2 corresponds to a standard moving state estimation unit and estimates a standard moving state in the current location with the environment information acquired by the environment information acquisition unit 1.

The vehicle information acquisition unit 3 corresponds to a mobile object information acquisition unit and acquires mobile object information indicating a moving state of the mobile object.

The current traveling state estimation unit 4 corresponds to a current moving state estimation unit, and estimates a current moving state of the mobile object with the mobile object information acquired by the mobile object information acquisition unit.

The difference determination unit 5 determines whether there is a difference between the standard moving state and the current moving state of the mobile object, by comparing the standard moving state and the current moving state of the mobile object.

If the difference determination unit 5 determines that there is the difference, the evaluation information acquisition unit 6 acquires evaluation information existing within the preset map range including the current location.

If the number of pieces of evaluation information acquired by the evaluation information acquisition unit 6 is less than a threshold, the inquiry decision unit 7 decides to inquire of the user, which is the mobile object, so as to collecting evaluation information.

Evaluation information collecting systems 10 according to the subsequent second to fourth embodiments can be employed for the mobile object, and their descriptions will be omitted.

### Second Embodiment

In the configuration of the first embodiment, if the number of pieces of evaluation information acquired by the evaluation information acquisition unit 6 is already equal to or larger than the threshold, it is determined that the reliability of evaluation information with respect to some event existing in the periphery of the location of the user's vehicle is high, and the inquiry to the driver is not made. In the case of this configuration, the inquiry is not made even if the content of already-existing evaluation information is entirely unrelated to an event currently existing in the periphery of the location of the user's vehicle. Accordingly, there is a possibility that appropriate evaluation information with respect to the event currently existing in the periphery of the location of the user's vehicle cannot be collected.

For example, in the case where the user's vehicle gets caught up in a traffic jam and rapidly decelerates, and the difference determination unit 5 determines that there exists a difference between the standard traveling state and the current traveling state, and if the number of pieces of evaluation information related to landscape in the periphery of the location of the user's vehicle is already equal to or larger than the threshold, the inquiry decision unit 7 decides not to make an inquiry notwithstanding that the event of the traffic jam and the event of the landscape are entirely unrelated.

Accordingly, the evaluation information collecting system 10 according to the second embodiment estimates the type of evaluation information related to an event currently existing in the periphery of the location of the user's vehicle, from parameters of the standard traveling state and the current traveling state, between which a difference exists, which is determined by the difference determination unit 5, and the evaluation information collecting system 10 decides whether to make an inquiry, by comparing the number of pieces of evaluation information of the estimated type with a threshold.

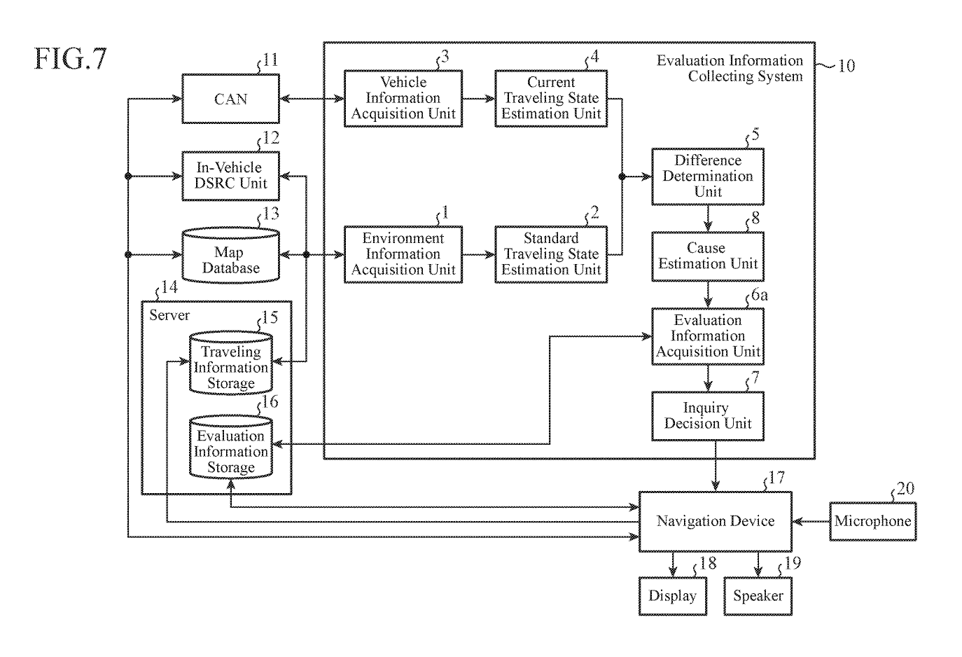

FIG. 7 is a block diagram illustrating a configuration example of the evaluation information collecting system 10 according to the second embodiment. The evaluation information collecting system 10 according to the second embodiment has a configuration in which a cause estimation unit 8 is added to the evaluation information collecting system 10 of the first embodiment illustrated in FIG. 1. In FIG. 7, the same or corresponding portions as those of FIG. 1 are designated by the same reference numerals, and their descriptions will be omitted.

The cause estimation unit 8 is implemented by the CPU 101 illustrated in FIG. 3 executing a program stored in the ROM 102 or the external storage device 105.

The cause estimation unit 8 receives a determination result from the difference determination unit 5, estimates a cause leading to a difference between the standard traveling state and the current traveling state with the determination result, identifies the type of evaluation information related to the cause, and outputs the type to an evaluation information acquisition unit 6a.

A correspondence table in which correspondence relationship between parameters of the standard traveling state and the current traveling state, and types of evaluation information is set is given in advance to the cause estimation unit 8. If the difference determination unit 5 determines that there is a difference between the standard traveling state and the current traveling state, the cause estimation unit 8 identifies the type of evaluation information related to the parameter determined to have a difference in the correspondence table.

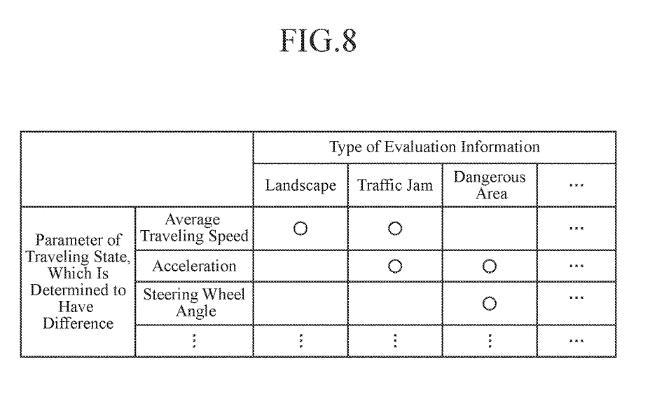

Here, FIG. 8 illustrates an example of the correspondence table between parameters of a traveling state and types of evaluation information, which are used by the cause estimation unit 8. In the correspondence table, correspondence relationship between parameters of the standard traveling state and the current traveling state, and types of evaluation information is set. In the correspondence table, a mark “∘ (Yes)” represents the correspondence between the parameter and the type of evaluation information.

Specifically, when the difference determination unit 5 determines that there exists a difference in the average traveling speed, the cause estimation unit 8 identifies that types of evaluation information represented as “landscape” and “traffic jam” are the types of evaluation information related to an event currently existing in the periphery of the user's vehicle because the mark “∘ (Yes)” is illustrated in the column of “average traveling speed” in the correspondence table.

Incidentally, the correspondence table illustrated in FIG. 8 is an example, and the correspondence relationship between types of evaluation information and parameters may be differently provided other than this combination. For example, as described in the above first embodiment, if ±20 km/h is set as the threshold of the average traveling speed in the standard traveling state, different types of evaluation information may be combined for each threshold. For example, in the case where a difference between the average traveling speeds in the standard traveling state and the current traveling state is equal to or larger than a threshold of 20 km/h, “traffic jam occurs” is associated with a type, and in the case where the difference above is less than a threshold of −20 km/h, “traffic jam is over” is associated with a type.

The evaluation information acquisition unit 6a receives the type of evaluation information from the cause estimation unit 8, and acquires, among evaluation information pieces existing within the preset map range, centering on the location of the user's vehicle, only evaluation information having the type identified by the cause estimation unit 8, from the evaluation information storage 16 of the server 14.

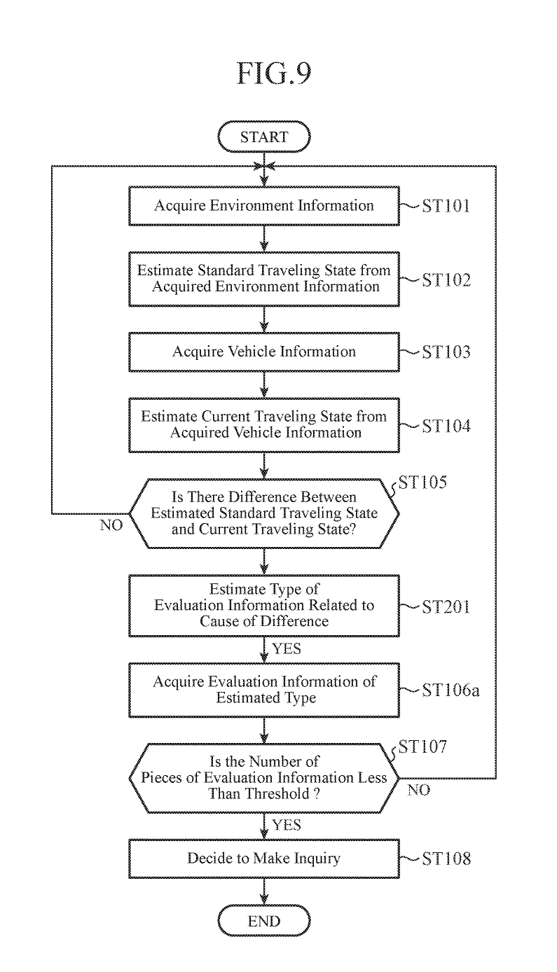

Next, the operation of the evaluation information collecting system 10 according to the second embodiment will be described with a flowchart illustrated in FIG. 9. Here, steps ST101 to ST105, ST107, and ST108 illustrated in FIG. 9 are the same as those in the flowchart illustrated in FIG. 6 in the first embodiment. Thus, the description thereof will be omitted.

When the difference determination unit 5 determines that there exists a difference between the standard traveling state and the current traveling state (step ST105 “YES”), the cause estimation unit 8 identifies, using the correspondence table illustrated in FIG. 8, the types of evaluation information related to the parameters determined to have a difference, and outputs the types to the evaluation information acquisition unit 6a (step ST201).

For example, when the difference determination unit 5 determines that there exists a difference in the acceleration between the standard traveling state and the current traveling state, the cause estimation unit 8 identifies, using the correspondence table illustrated in FIG. 8, that types “traffic jam” and “dangerous area” are types related to an event currently existing in the periphery of the location of the user's vehicle because the mark “∘ (Yes)” is illustrated in the column of “acceleration”.

Following step ST201, the evaluation information acquisition unit 6a acquires, among evaluation information pieces existing within the preset map range, centering on the location of the user's vehicle, evaluation information having the types identified by the cause estimation unit 8, from the evaluation information storage 16 of the server 14, and outputs the evaluation information to the inquiry decision unit 7 (step ST106a).

If the number of pieces of evaluation information acquired by the evaluation information acquisition unit 6a is less than the threshold (step ST107 “YES”), the inquiry decision unit 7 decides to make an inquiry and instructs the navigation device 17 (step ST108).

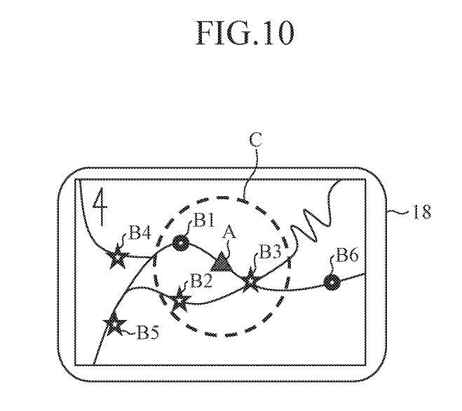

Here, FIG. 10 illustrates an example of a map screen displayed on the display 18 by the navigation device 17. In FIG. 10, the evaluation information pieces B1 and B6 of “dangerous area” and the evaluation information pieces B2 to B5 of “traffic jam” exist in the periphery of the location A of the user's vehicle. If the types of evaluation information identified by the cause estimation unit 8 are “traffic jam”, the evaluation information acquisition unit 6a acquires the evaluation information pieces B2 and B3 of “traffic jam” existing in the map range C having a radius of 1 km centering on the location A of the user's vehicle, and does not acquire the evaluation information B1 of “dangerous area” existing in the map range C.

In addition, if the parameter having a difference, which is determined by the difference determination unit 5, is the acceleration, the cause estimation unit 8 identifies, according to the correspondence table, two types “traffic jam” and “dangerous area”. The evaluation information acquisition unit 6a accordingly acquires the evaluation information pieces B2 and B3 of the type “traffic jam” and the evaluation information B1 of the type “dangerous area” that exist in the map range C having a radius of 1 km, centering on the location A of the user's vehicle. If there are a plurality of types of evaluation information acquired by the evaluation information acquisition unit 6a, the inquiry decision unit 7 compares, for example, in consideration of only evaluation information pieces of the type having the largest acquisition numbers, the number of pieces of evaluation information with the threshold, and determines whether to make an inquiry.

As described above, according to the second embodiment, because the evaluation information collecting system 10 includes the cause estimation unit 8 for identifying the type of evaluation information related to a cause leading to a difference between the standard traveling state and the current traveling state, and the inquiry decision unit 7 decides to make an inquiry in a case in which the number of pieces of evaluation information of the type identified by the cause estimation unit 8 is less than the threshold, so that the inquiry can be selectively made in the case in which pieces of evaluation information of the type related to the cause leading to the difference between the standard traveling state and the current traveling state are not sufficiently collected, and the reliability of the evaluation information collected can be improved.

### Third Embodiment

In the first embodiment, after the inquiry decision unit 7 has decided to make an inquiry, the navigation device 17 immediately inquires of the driver with preset inquiry words.

However, since the preset inquiry words are abstractive inquiries such as “What happen?” and “What is the problem?”, there is a possibility that the driver utters various types of evaluation comments. In this case, evaluation information entirely unrelated to some event existing in the periphery of the location of the user's vehicle is collected. With such evaluation information, it is conceivable that pieces of evaluation information related to an event existing in the periphery of the location of the user's vehicle cannot be sufficiently collected, which reduces the reliability of evaluation information.

In addition, when an inquiry to the driver is immediately made at timing at which the inquiry decision unit 7 decides to make the inquiry, in some cases, the inquiry is started at timing at which the driver is concentrating on the driving, which may cause the hindrance of the driving.

Specifically, in the case where the driver gets caught up in a traffic jam, and if the navigation device 17 inquires of the drive “what happen?”, the driver may speak not only an evaluation comment indicating “traffic is heavy”, but also evaluation comments entirely unrelated to the traffic jam, such as “I am hungry” and “I want to go to the bathroom”.

In addition, if the navigation device 17 makes an inquiry in an area such as sharp curve where the driver needs to concentrate on the driving, the inquiry distracts the driver in driving

Thus, the evaluation information collecting system 10 according to the third embodiment changes an inquiry mode according to an event existing in the periphery of the location of the user's vehicle. An inquiry mode to be changed is at least either one of inquiry words and inquiry timing.

By making an inquiry with words related to an event existing in the periphery of the location of the user's vehicle, pieces of evaluation information only related to the event are collected, and the reliability of the evaluation information is improved. In addition, if an event requiring concentration on driving exists in the periphery of the user's vehicle, a hindrance to the driving due to the inquiry can be reduced by changing the inquiry timing.

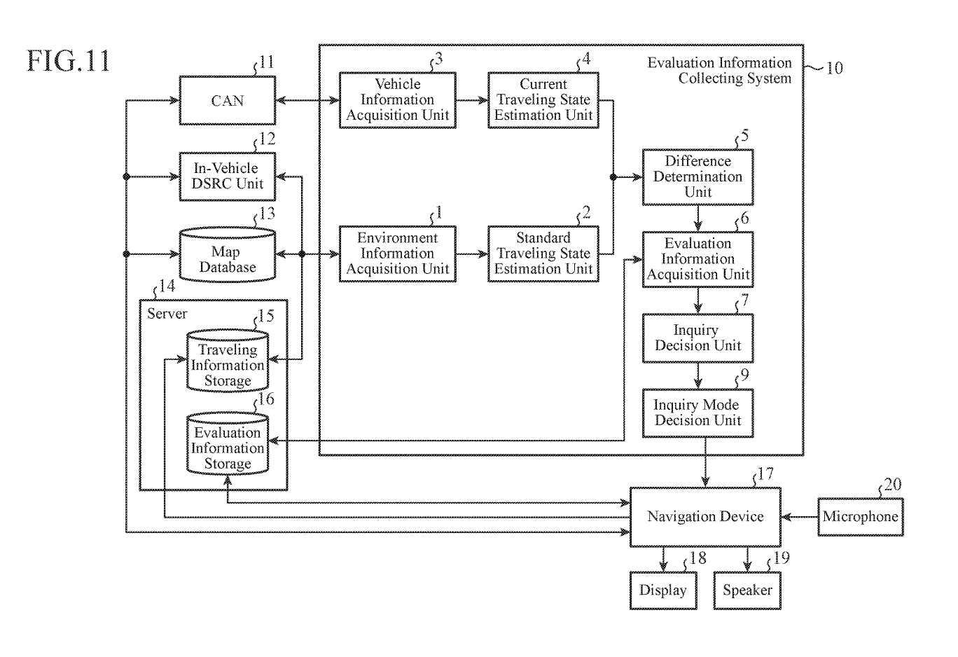

FIG. 11 is a block diagram illustrating a configuration example of the evaluation information collecting system 10 according to the third embodiment. The evaluation information collecting system 10 according to the third embodiment has a configuration in which an inquiry mode decision unit 9 is added to the evaluation information collecting system 10 of the first embodiment illustrated in FIG. 1. In FIG. 11, the same or corresponding portions as those of FIG. 1 are designated by the same reference numerals, and their descriptions will be omitted.

The inquiry mode decision unit 9 is implemented by the CPU 101 illustrated in FIG. 3 executing a program stored in the ROM 102 or the external storage device 105.

If the inquiry decision unit 7 decides to make an inquiry, the inquiry decision unit 7 issues notification indicating the decision, and outputs the evaluation information acquired by the evaluation information acquisition unit 6, to the inquiry mode decision unit 9.

If the inquiry mode decision unit 9 receives, from the inquiry decision unit 7, the notification indicating that it is decided to make the inquiry, the inquiry mode decision unit 9 decides an inquiry mode according to the type of evaluation information acquired by the evaluation information acquisition unit 6. In addition, the inquiry mode decision unit 9 instructs the navigation device 17 to inquire of the driver with the decided mode.

A correspondence table, in which correspondence relationship between types of evaluation information, inquiry words, and inquiry timing is set, is given in advance to the inquiry mode decision unit 9. If the inquiry decision unit 7 decides to make an inquiry, the inquiry mode decision unit 9 decides, using the correspondence table, an inquiry mode corresponding to the type of evaluation information.

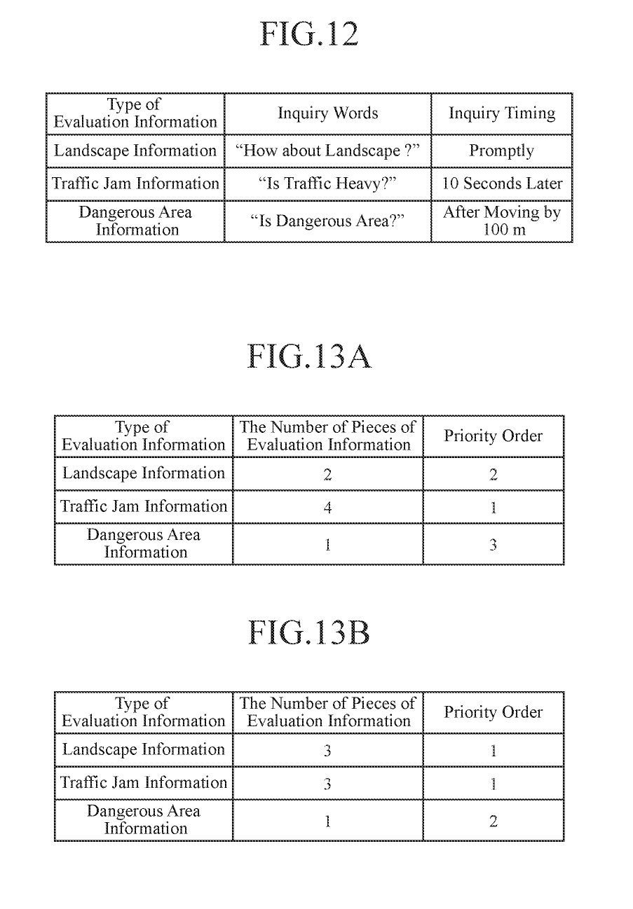

Here, FIG. 12 illustrates an example of the correspondence table between types of evaluation information and inquiry modes, which is used by the inquiry mode decision unit 9. If the type of evaluation information is “landscape”, a driving operation that requires concentration is not performed, and therefore an inquiry such as “how about landscape?” may be “promptly” made. In contrast, when the vehicle gets caught up in a traffic jam, the vehicle needs to decelerate, and therefore the inquiry should be made after the completion of deceleration. Thus, if the type of evaluation information is “traffic jam”, “10 seconds later” is set as timing at which the deceleration completes. In addition, the driver needs to concentrate on driving until the vehicle passes through a dangerous area, and if the type of evaluation information is “dangerous area”, “after moving by 100 m” is set as timing at which the vehicle has completely passed through the dangerous area.

Incidentally, the correspondence table illustrated in FIG. 12 is an example, and does not limit inquiry words and inquiry timing.

In addition, if there are a plurality of types of evaluation information acquired by the evaluation information acquisition unit 6, the inquiry mode decision unit 9 sets a priority order for each type, and identifies the type of evaluation information, for which an inquiry is made, based on the priority order.

For example, the inquiry mode decision unit 9 sets a higher priority order for a type of evaluation information acquired by the evaluation information acquisition unit 6 as the number of pieces of evaluation information increases, and decides a dedicated inquiry mode corresponding to the type having the highest priority order, that is, the type having the largest number of pieces of evaluation information acquired by the evaluation information acquisition unit 6.

Here, FIG. 13A illustrates an example of a method for identifying the type of evaluation information for which an inquiry is made. As illustrated in FIG. 13A, it is assumed that a breakdown of types of evaluation information acquired by the evaluation information acquisition unit 6 is two pieces of “landscape”, four pieces of “traffic jam”, and one piece of “dangerous area”. In this case, the inquiry mode decision unit 9 sets the first priority order for the evaluation information of “traffic jam” having the largest acquisition number of four, and identifies as the type for which an inquiry is made. In addition, the inquiry mode decision unit 9 decides, using the correspondence table illustrated in FIG. 12, inquiry words “Is traffic heavy?” and inquiry timing “10 seconds later”, and instructs the navigation device 17. At timing at which 10 seconds have elapsed from a time point at which the instructions for making an inquiry have been received from the inquiry mode decision unit 9, the navigation device 17 instructs the speaker 19 to output audio guidance such as, for example, “Is traffic heavy?”.

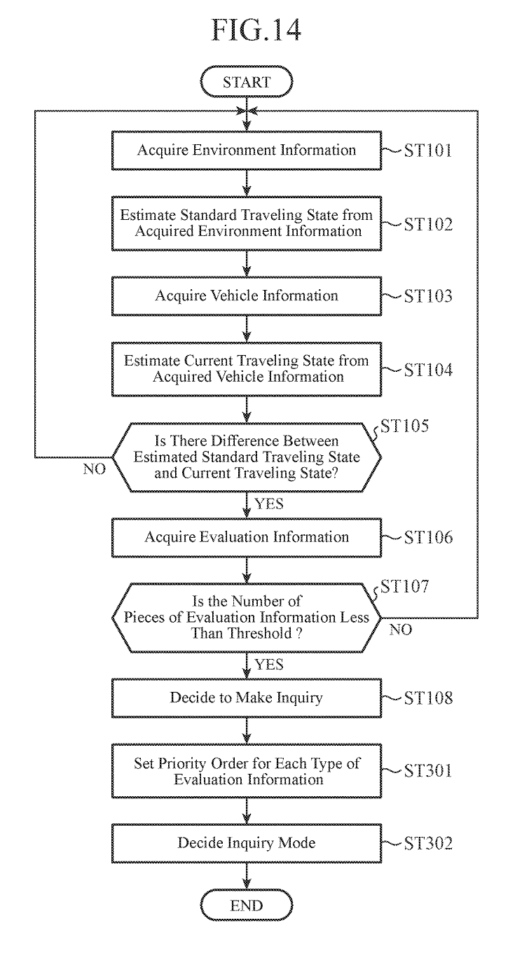

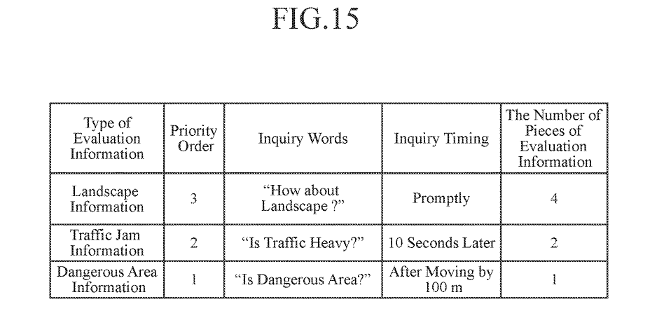

Next, the operation of the evaluation information collecting system 10 according to the third embodiment will be described with a flowchart illustrated in FIG. 14. Here, steps ST101 to ST108 illustrated in FIG. 14 are the same as those in the flowchart illustrated in FIG. 6 in the first embodiment. Thus, the description thereof will be omitted.

If the inquiry decision unit 7 decides to make an inquiry (step ST108), the inquiry mode decision unit 9 sets a priority order for each type of evaluation information (step ST301). As illustrated in FIG. 13A, a priority order becomes higher for a type as the number of pieces of evaluation information increases.

Subsequently, the inquiry mode decision unit 9 decides, using a correspondence table as illustrated in FIG. 12, inquiry words and inquiry timing corresponding to the type of evaluation information having the highest priority order, as an inquiry mode, and instructs the navigation device 17 (step ST302).

After step ST302, the evaluation information collecting system 10 returns again to step ST101, and executes again the processing in steps ST101 to ST108, ST301, and ST302.

In addition, in step ST301, if the type having the highest priority order cannot be identified, for example, if a plurality of types have the same number of pieces of evaluation information, the inquiry mode decision unit 9 decides general-purpose words unrelated to types, as inquiry words, similarly to the first embodiment, and instructs the navigation device 17.

For example, as illustrated in FIG. 13B, if the number of pieces of evaluation information of “landscape” is three, and the number of pieces of evaluation information of “traffic jam” is also three, there are two types having the first priority order, the type having the highest priority order cannot be identified. Thus, the inquiry mode decision unit 9 decides preset general-purpose words such as “What happen?” and “What is the problem?”, as inquiry words.

As described above, according to the third embodiment, the evaluation information collecting system 10 includes the inquiry mode decision unit 9, and if the inquiry decision unit 7 decides to make an inquiry, the inquiry mode decision unit 9 identifies a type, for which the inquiry is made, based on a priority order set for each type of evaluation information acquired by the evaluation information acquisition unit 6, and decides an inquiry mode in accordance with the identified type, so that the inquiry can be preferentially made with respect to the evaluation information related to an event existing in the periphery of the location of the user's vehicle, and the reliability of the evaluation information can be improved.

In addition, according to the third embodiment, the inquiry mode decision unit 9 sets a higher priority order for a type of evaluation information acquired by the evaluation information acquisition unit 6 as the number of pieces of evaluation information increases, and identifies the type having the highest priority order, as the type of evaluation information for which an inquiry is made, and decides inquiry words in accordance with the identified type, so that the inquiry mode decision unit 9 can urge the driver to speak an evaluation comment related to an event existing in the periphery of the location of the user's vehicle. Accordingly, the evaluation information related to an event existing in the periphery of the location of the user's vehicle can be collected, and the reliability of the evaluation information can be improved.

In addition, according to the third embodiment, because the inquiry mode decision unit 9 sets a higher priority order for the type of evaluation information acquired by the evaluation information acquisition unit 6 as the number of pieces of evaluation information increases, and identifies the type having the highest priority order, as the type of evaluation information for which an inquiry is made, and decides the inquiry timing in accordance with the identified type, so that the inquiry can be started at timing at which a burden on the driver is lessened, and a hindrance to the driving can be reduced.

### Fourth Embodiment

The configuration of the evaluation information collecting system 10 according to the fourth embodiment is the same as the configuration illustrated in FIG. 11 in the above-described third embodiment. Thus, the fourth embodiment will be described below with reference to FIG. 11.

The inquiry mode decision unit 9 of the third embodiment sets a higher priority order for the type of evaluation information acquired by the evaluation information acquisition unit 6 as the number of pieces of evaluation information increases. In contrast to this, in the fourth embodiment, a priority order is preset for each type of evaluation information regardless of the number of pieces of evaluation information.

A correspondence table, in which correspondence relationship between types of evaluation information and priority orders is set, is given in advance to the inquiry mode decision unit 9 of the fourth embodiment. If the inquiry decision unit 7 decides to make an inquiry, the inquiry mode decision unit 9 identifies, using the correspondence table, the type having the highest priority order from among types of evaluation information acquired by the evaluation information acquisition unit 6, and identifies a type for which the inquiry is made. In addition, similarly to the above-described third embodiment, the inquiry mode decision unit 9 decides, using the correspondence table in which a correspondence relationship between types of evaluation information and inquiry modes is set, at least either one of inquiry word and inquiry timing in accordance with the type having the highest priority order, and instructs the navigation device 17.

Here, FIG. 15 illustrates an example of a correspondence table between types of evaluation information and priority orders, which is used by the inquiry mode decision unit 9. The evaluation information of “dangerous area” has a substantial effect on driving, and the reliability needs to be improved by collecting a large number of pieces of evaluation information, and therefore the first priority order is set for the type of evaluation information of “dangerous area”. The evaluation information of “traffic jam” has a small effect on driving as compared with the evaluation information of “dangerous area”, and therefore the second priority order is set for the type of evaluation information of “dangerous area”. The evaluation information of “landscape” has the smallest effect on driving as compared with the evaluation information pieces of “dangerous area” and “traffic jam”, and therefore the third priority order is set for the type of evaluation information of “landscape”.

In addition, in the correspondence table illustrated in FIG. 15, a correspondence relationship between types of evaluation information and inquiry modes is also set. This correspondence relationship is similar to the correspondence relationship illustrated in FIG. 12 in the above-described third embodiment. Thus, the description thereof will be omitted.

In addition, the correspondence table illustrated in FIG. 15 is an example, and does not limit the combination of types of evaluation information and priority orders, and inquiry words and inquiry timing.

The correspondence relationship between types of evaluation information and priority orders may be set by the user such as the driver. If the same priority order is set for a plurality of types, which is attributed to a change in the settings of the priority order or the like performed by the user, the inquiry mode decision unit 9 only needs to identify the type having the largest number of pieces of evaluation information, as a type for which an inquiry is made.

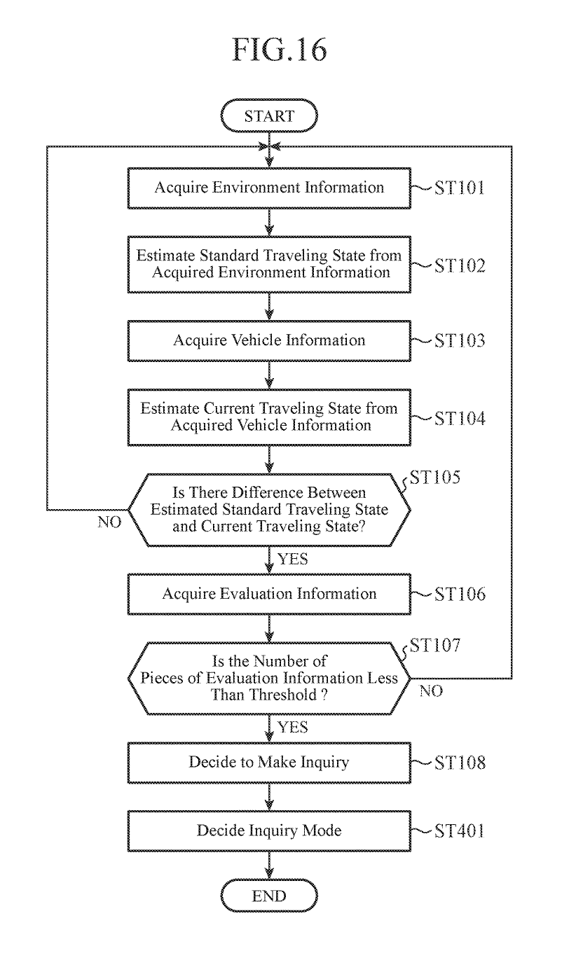

Next, the operation of the evaluation information collecting system 10 according to the fourth embodiment will be described with a flowchart illustrated in FIG. 16. Here, steps ST101 to ST108 illustrated in FIG. 16 are the same as those in the flowchart illustrated in FIG. 6 in the first embodiment. Thus, the description thereof will be omitted.

If the inquiry decision unit 7 decides to make an inquiry (step ST108), the inquiry mode decision unit 9 identifies, using a correspondence table as illustrated in FIG. 15, the type having the highest priority order among types of evaluation information acquired by the evaluation information acquisition unit 6, and decides inquiry words and inquiry timing in accordance with the identified type, as an inquiry mode, and instructs the navigation device 17 (step ST401).

After step ST401, the evaluation information collecting system 10 returns again to step ST101, and executes again the processing in steps ST101 to ST108, and ST401.

For example, in the correspondence table illustrated in FIG. 15, the acquisition number of pieces of evaluation information of “landscape” is four, which is the largest number among the types of evaluation information acquired by the evaluation information acquisition unit 6, but the third priority order is set for the type of evaluation information of “landscape”. In contrast, the acquisition number of pieces of evaluation information of “dangerous area” is one, which is the smallest number among the types of evaluation information acquired by the evaluation information acquisition unit 6, but the first priority order is set for the type of evaluation information of “dangerous area”. In this case, the inquiry mode decision unit 9 decides inquiry words “Is it dangerous area?” and inquiry timing “after moving by 100 m” in accordance with the type of evaluation information of “dangerous area”, which has the highest priority order, regardless of the number of pieces of evaluation information, and instructs the navigation device 17. At timing at which the user's vehicle has moved by 100 m from the location of the user's vehicle at the time point at which the instructions for making an inquiry have been received from the inquiry mode decision unit 9, the navigation device 17 instructs the speaker 19 to output audio guidance such as, for example, “Is it dangerous area?”.

As described above, according to the fourth embodiment, the inquiry mode decision unit 9 identifies the type of evaluation information for which an inquiry is made, based on the priority order preset for each type of evaluation information, so that the inquiry can be preferentially made with respect to the type of evaluation information for which the reliability needs to be improved, and the reliability of the evaluation information can be improved.

In addition, according to the fourth embodiment, if there is evaluation information of a specific type among pieces of evaluation information acquired by the evaluation information acquisition unit 6, the inquiry mode decision unit 9 decides an inquiry mode corresponding to the specific type, so that the inquiry mode decision unit 9 can urge the driver to speak an evaluation comment about an event related to evaluation information of the specific type having a substantial effect on driving and having great necessity of improving the reliability, such as, for example, “dangerous area”, and the reliability of the evaluation information can be efficiently improved for the specific type.

In addition, in the present invention, the embodiments can be freely combined, any constituent element of the embodiments can be modified, or any constituent element of the embodiments can be omitted, without departing from the scope of the invention.

### INDUSTRIAL APPLICABILITY

The evaluation information collecting system according to the present invention inquires of a user about evaluation information of the periphery of a current location. Thus, the evaluation information collecting system is suitable for being used in an evaluation information collecting system for various mobile objects including persons, vehicles, ships, aircrafts, and the like.

### REFERENCE SIGNS LIST

1 environment information acquisition unit
2 standard traveling state estimation unit (standard moving state estimation unit)
3 vehicle information acquisition unit (mobile object information acquisition unit)
4 current traveling state estimation unit (current moving state estimation unit)
5 difference determination unit
6, 6a evaluation information acquisition unit
7 inquiry decision unit
8 cause estimation unit
9 inquiry mode decision unit
10 evaluation information collecting system
11 CAN
12 in-vehicle DSRC unit
13 map database
14 server
15 traveling information storage
16 evaluation information storage
17 navigation device
18 display
19 speaker
20 microphone
100 bus
101 CPU
102 ROM
103 RAM
104 communication device
105 external storage device

1. An evaluation information collecting system comprising:
an environment information acquirer to acquire environment information indicating peripheral surroundings at a current location of a mobile object;
a standard moving state estimator to estimate a standard moving state at the current location with the environment information acquired by the environment information acquirer;
a mobile object information acquirer to acquire mobile object information indicating a moving state of the mobile object;
a current moving state estimator to estimate a current moving state of the mobile object with the mobile object information acquired by the mobile object information acquirer;
a difference determiner to determine whether there is a difference between the standard moving state and the moving state of the mobile object, by comparing the standard moving state with the moving state of the mobile object;
an evaluation information acquirer to acquire evaluation information existing within a preset map range including the current location, in a case in which it is determined by the difference determiner that there is the difference; and
an inquiry decider to decide to make an inquiry so as to collect the evaluation information, in a case in which the number of pieces of evaluation information acquired by the evaluation information acquirer is less than a threshold.

2. The evaluation information collecting system according to claim 1, further comprising a cause estimator to identify a type of evaluation information related to a cause leading to a difference between the standard moving state and the moving state of the mobile object,
wherein the inquiry decider decides to make an inquiry in a case in which the number of pieces of evaluation information of the type identified by the cause estimator is less than a threshold.

3. The evaluation information collecting system according to claim 1, further comprising an inquiry mode decider to, in a case in which the inquiry decider decides to make an inquiry, identify a type for which the inquiry is made, based on a priority order of each type of evaluation information acquired by the evaluation information acquirer, and decide an inquiry mode according to the identified type.

4. The evaluation information collecting system according to claim 3, wherein a higher priority order is set for a type of evaluation information acquired by the evaluation information acquirer as the number of pieces of evaluation information increases.

5. The evaluation information collecting system according to claim 4, wherein the inquiry mode decider identifies a type having a highest priority order, as a type of evaluation information for which an inquiry is made, and decides inquiry words in accordance with the identified type.

6. The evaluation information collecting system according to claim 5, wherein, in a case in which the type having the highest priority order cannot be identified, the inquiry mode decider decides general-purpose inquiry words unrelated to types.

7. The evaluation information collecting system according to claim 4, wherein the inquiry mode decider identifies a type having the highest priority order, as a type of evaluation information for which inquiry is made, and decides timing of an inquiry in accordance with the identified type.

8. The evaluation information collecting system according to claim 3, wherein a priority order is preset for each type of evaluation information.

9. The evaluation information collecting system according to claim 8, wherein, in a case in which there is evaluation information of a specific type among pieces of evaluation information acquired by the evaluation information acquirer, the inquiry mode decider decides an inquiry mode in accordance with the specific type.
